(19) United States
(12) Patent Application Publication
(10) Pub. No.: US 2008/0145201 A1
(43) Pub. Date: Jun. 19, 2008

(54) ADJUSTABLE FIXED ROLLER CARTRIDGE SYSTEM

(76) Inventors: Dane W. Gregg, Uniontown, OH (US); Pete J. Savoy, Akron, OH (US); Sean Donaldson, Stow, OH (US)

Correspondence Address: BROUSE MCDOWELL LPA, 388 SOUTH MAIN STREET, SUITE 500, AKRON, OH, 44311, US

(21) Appl. No.: 11/856,146

(22) Filed: Sep. 17, 2007

Related U.S. Application Data
(60) Provisional application No. 60/825,964, filed on Sep. 18, 2006.

(51) Int. Cl. B60P 1/44; B65G 13/00

(52) U.S. Cl. 414/545; 193/35 R

(57) ABSTRACT

A liftgate platform assembly may include a roller assembly having a pair of roller cartridge assemblies that are attached within a channel on opposite sides of a rail member. One roller cartridge assembly may be considered a fixed roller assembly because it does not move relative to the rail member and the other may be considered an adjustable roller assembly because it can move relative to the rail member.

This application claims priority from US provisional patent application Ser. No. 60/825,964 titled ADJUSTABLE FIXED ROLLER CARTRIDGE SYSTEM filed on Sep. 18, 2006, which is incorporated herein by reference.

### I. BACKGROUND OF THE INVENTION

A. Field of Invention

This invention pertains to the art of methods and apparatuses regarding liftgates and more specifically to methods and apparatuses regarding raising and lowering liftgates.

B. Description of the Related Art

It is well known in the art to attach liftgates to vehicle trailers or other forms of vehicle cargo holds to assist with loading and unloading of the vehicles. In general, liftgates include a platform or deck and an adjustment system used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. FIG. 1 shows a known liftgate assembly 1, a rail type liftgate, including a platform assembly 2 that has a deck or platform 3 attached, typically welded, to a platform support structure 4 that may have multiple brace members 5. The platform assembly 2 may be pivotally connected, about pivot pins 6, so that the platform assembly 2 may be folded up when not in use. The platform assembly 2 may be raised and lowered along rails 7, 7. More specifically, runners 8, 8, connected to the platform assembly 2, can be moved up and down on the rails 7, 7. The connection between each runner 8 and each rail 7 includes a roller assembly 9 attached to the runner 8 and having rollers 10 that are received in a channel formed in the rail 7. As the platform assembly 2 is raised and lowered, the rollers 10 rotate while their outer surfaces contact the inner surfaces of the rail channel. While known roller assemblies generally work well for their intended purpose, they have disadvantages.

One disadvantage is that known roller assemblies are either attached to the moving guide structure (such as the previously noted runners 8) or fixed in a stationary position on the fixed guide structure (such as the previously noted rails 7). Neither of these systems is adjustable to account for manufacturing, installation, or deformation tolerances or varied loads. Wear to rollers and bearing systems shorten the operational life of the roller and bearing system. Flat spotting of rollers leads to increase parasitic loss in the system, increasing the energy consumption, reducing the cycles a liftgate system will achieve on a single battery charge, and reducing the life of the hydraulic pump. Lateral loads on the moving guide structure cause elastic, lateral deformation of the moving guide structure. Deformation in the lower section of the moving guide structure between the bottom, fixed roller and the platform causes the platform to become un-level.

Another problem is related to the fact that liftgate assemblies, including the roller assemblies, are often cleaned, typically pressure washed, regularly. Such cleaning introduces cleaning solutions into the roller assemblies which can shorten their active life.

The present invention provides methods and apparatuses regarding an adjustable liftgate roller cartridge assembly that overcomes the foregoing difficulties and others while providing better and more advantageous overall results.

### II. SUMMARY OF THE INVENTION

According to one embodiment of this invention, a liftgate platform assembly includes a roller assembly having a pair of roller cartridge assemblies that are attached within a channel on opposite sides of a rail member. One roller cartridge assembly may be considered a fixed roller assembly because it does not move relative to the rail member and the other may be considered an adjustable roller assembly because it can move relative to the rail member.

According to another embodiment of this invention, each roller cartridge assembly includes a cartridge and at least one roller that pivots or rolls within the cartridge

According to another embodiment of this invention, the roller cartridge assemblies can be assembled to precise tolerances and then installed as pre-assembled units.

According to yet another embodiment of this invention, a method comprising the steps of:

(A) providing a liftgate assembly comprising: at least one rail member that may be attached to an associated vehicle, the rail member comprising a channel; at least one runner that is movable within the channel, the runner comprising first and second engagement surfaces; and, a platform operatively attached to the runner, the platform comprising a traffic surface that may be used to receive traffic for loading and unloading cargo;

(B) providing a first roller cartridge assembly comprising a cartridge and at least one roller that pivots within the cartridge;

(C) providing a second roller cartridge assembly comprising a cartridge and at least one roller that pivots within the cartridge;

(D) movably attaching the first roller cartridge assembly to the rail member so that the first roller cartridge assembly roller may contact the first engagement surface of the runner; and,

(E) fixedly attaching the second roller cartridge assembly to the rail member so that the second roller cartridge assembly roller may contact the second engagement surface of the runner.

One advantage of this invention is that the performance and stability of the liftgate guide system is improved. The moving guide structure cannot disengage from the rollers due to side loading of the moving guide structure caused by off center loading of the liftgate platform. Such side loading may also generate a side load in the lift cylinder. Side loads in the lift cylinder accelerates wear of its internal seals, decreasing the life of the lift cylinder. This invention greatly reduces such cylinder wear.

Another advantage of this invention is that the adjustable roller cartridge assembly can be used to account for wear in the roller bearings, leading to less roller replacements and longer periods of service without disruption.

Another advantage of this invention is that the adjustable roller cartridge assembly accounts for conditions where there is little to no lateral load on the guide system by generating a pre-load on the guide system.

Still another advantage of this invention is that the adjustable roller cartridge assembly can be used to adjust the level of the platform.

Another advantage of this invention is that the system will not bind and cause flat spots in interfacing parts. Preloading the moving guide structure with the adjustable roller cartridge assembly counter-acts the deformation in the lower section for the moving guide structure, maintaining a more level platform.

Another advantage of this invention is that liftgate assembly costs can be minimized.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a plan perspective view of a prior art rail type liftgate illustrating the currently known roller assemblies.

FIG. 2 is a plan view of a portion of a liftgate assembly illustrating the use of a pair of roller cartridge assemblies according to one embodiment of this invention.

FIG. 3 is a top view illustrating how a rail member may be attached to a vehicle.

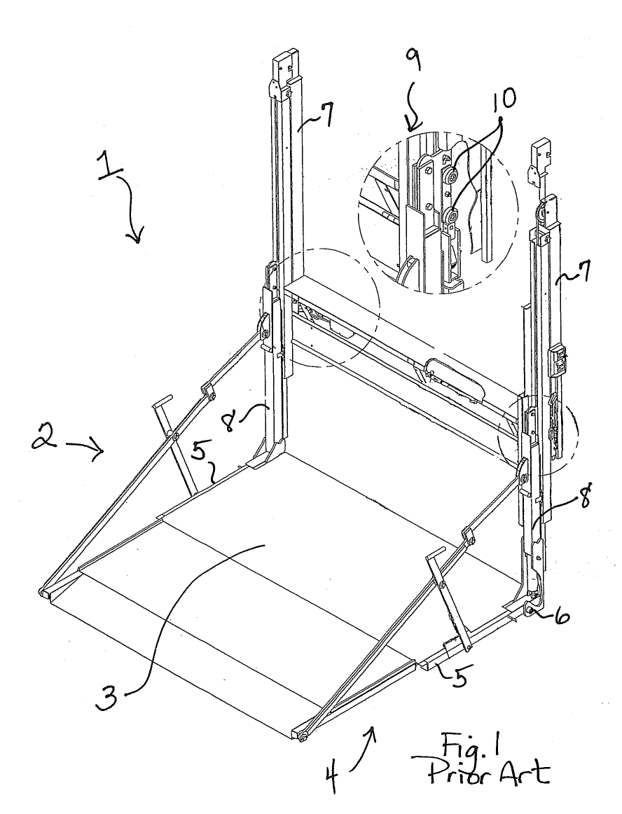

### IV. DETAILED DESCRIPTION OF THE INVENTION

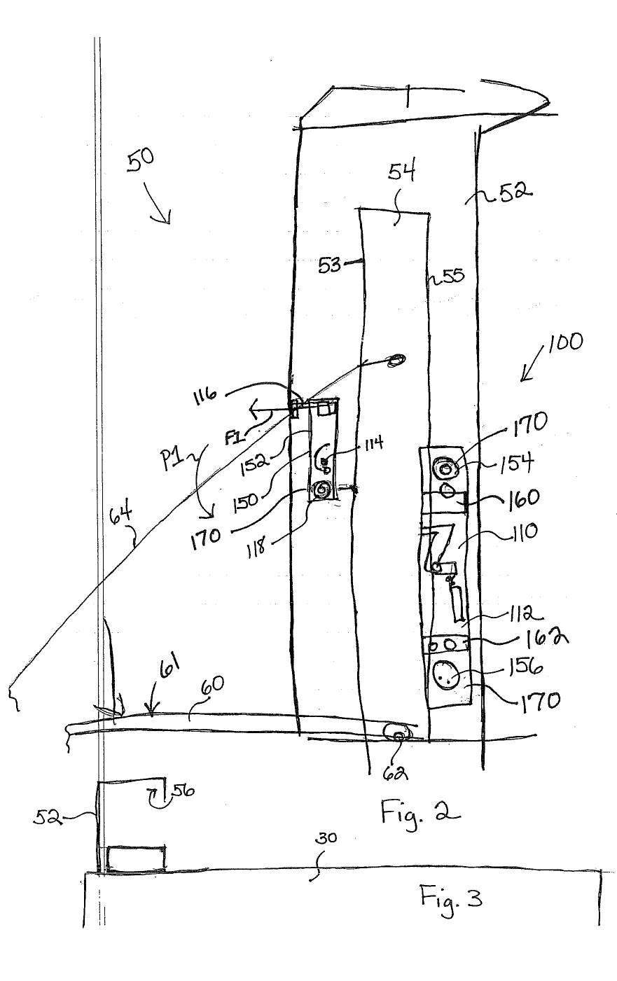

Referring now to the drawings wherein the showings are for purposes of illustrating embodiments of the invention only and not for purposes of limiting the same, FIG. 2 shows a portion of a rail type liftgate assembly 50 including a roller assembly 100 according to this invention. It should be noted, however, that this invention will work with other types of liftgates using roller assemblies as well. The liftgate assembly 50 includes a pair of column or rail members 52, one shown, that are fixedly attached to the corresponding vehicle 30, as illustrated in FIG. 3. The rail members 52 may have a G-shaped cross-section defining a channel 56. The liftgate assembly 50 also may include a pair of runners 54, one shown, that can be moved up and down within the channel 56. The runners 54 include engagement surfaces 53, 55 adapted to receive rollers as will be discussed further below. A liftgate deck or platform 60 may be pivotally attached about pivot pin 62 to the runners 54. The platform or deck 60 may include one or more generally planar sheet or plate members having a traffic surface 61 adapted to receive traffic for loading and unloading cargo. A pair of support members 64, one shown, may attach at one end to an outer extension of the platform 60 and at another end to the runners 54.

With continuing reference to FIG. 2, the roller assembly 100 may include a pair of roller cartridge assemblies 110, 150 that are attached within the channel 56 on opposite sides of the rail member 52. The roller cartridge assembly 110 may be considered a fixed roller assembly because it does not move, once installed, relative to the rail member 52. The roller cartridge assembly 150 may be considered an adjustable roller assembly because it can move relative to the rail member 52 as will described further below. Each roller cartridge assembly 110, 150 includes a cartridge 112, 152 and at least one roller that pivots or rolls within the cartridge 112, 152. Other components may be included within each cartridge 112, 152, some of which will be described below. Each cartridge 112, 152 performs as a housing protecting the rollers and other components against various environmental elements including, for non-limiting examples, road debris, salt spray and other corrosive materials, and cleaning solutions. Another advantage to the use of cartridges 112, 152 is that they permit the roller cartridge assemblies 110, 150 to be carefully assembled to precise tolerances. The roller cartridge assemblies 110, 150 can then be installed as pre-assembled units.

With continuing reference to FIG. 2, the roller cartridge assembly 150 may be pivotally connected to the rail member 52 about pivot pin 114. A force generating member 116 may be attached to the rail member 52 at one end of the cartridge to generate a force in direction F1. This causes the cartridge assembly 150 to pivot about pivot pin 114 in direction P1. In this way roller 118, which is rotatably attached to the cartridge 112, is held against the engagement surface 53 of the runner 54. This tends to keep the runner 54 in proper alignment with the roller cartridge assembly 110 and with the rail member 52. As a result, both manufacturing tolerances and installation tolerances are easily accounted for throughout the entire assembly process. In one embodiment, the force generating member 116 may be a simple screw adjustment welded on a block. A nut may then be tacked on the backside and a bolt may be inserted through the block.

Still referring to FIG. 2, the roller cartridge assembly 110 may be fixedly connected to the rail member 52 with pins or bolts. The roller cartridge assembly 110 may include a pair of rollers 154, 156 that contact engagement surface 55 of the runner 54 and that are rotatably attached to opposite ends of the cartridge 152. The roller cartridge assembly 150 may have other components within the cartridge 152 such as a power switch 160 that is removable and serviceable and a down stop mechanism 162. The power switch 160 and stop mechanism 162 may be operatively attached to a hydraulic system, not shown, used to adjust the position of the platform 60. This embodiment makes access to the switches very easy, it is only necessary to remove the cartridge 152, as compared to currently known systems which require disassembly of the entire system to get to the switches.

With continuing reference to FIG. 2, the roller cartridge assemblies 110, 150 provide a stable three points of contact with the runner 54 via the three rollers, 118, 154, 156. The roller cartridge assemblies 110, 150 may be attached to the rail member 52 with pins or bolts that can be easily removed. As a result, it is very easy to install and remove the roller cartridge assemblies 110, 150 as required. The roller cartridge assemblies 110, 150 may have grease fittings 170 so that the rollers can be serviced for maintenance.

Multiple embodiments have heard that there been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A liftgate assembly comprising:
at least one rail member that may be attached to an associated vehicle, the rail member comprising a channel;
at least one runner that is movable within the channel, the runner comprising first and second engagement surfaces;
a platform operatively attached to the runner, the platform comprising a traffic surface that may be used to receive traffic for loading and unloading cargo;
a roller assembly comprising:
(a) a first roller cartridge assembly movably attached to the rail member, the first roller cartridge assembly comprising a cartridge and at least one roller that pivots within the cartridge and that may contact the first engagement surface of the runner;
(b) a second roller cartridge assembly fixedly attached to the rail member, the second roller cartridge assembly comprising a cartridge and at least one roller that pivots within the cartridge and that may contact the second engagement surface of the runner.

2. The liftgate assembly of claim 1 wherein the platform is pivotally attached to the runner.

3. The liftgate assembly of claim 1 wherein the first and second roller cartridge assemblies are positioned within the channel on opposite sides of the rail member.

4. The liftgate assembly of claim 1 wherein the first roller cartridge assembly is pivotally connected to the rail member.

5. The liftgate assembly of claim 4 wherein the first roller cartridge assembly further comprises:
a force generating member that causes the first roller cartridge assembly to pivot in a predetermined direction to hold the roller of the first roller cartridge assembly against the first engagement surface of the runner.

6. The liftgate assembly of claim 1 wherein the second roller cartridge assembly further comprises:
a pair of rollers that are positioned on opposite ends of the cartridge and that pivot within the cartridge and contact the second engagement surface of the runner.

7. The liftgate assembly of claim 1 wherein the second roller cartridge assembly further comprises:
a power switch for use in adjusting the position of the platform, the power switch being mounted within the cartridge.

8. The liftgate assembly of claim 1 wherein the second roller cartridge assembly further comprises:
a down stop mechanism for use in adjusting the position of the platform, the down stop mechanism being mounted within the cartridge.

9. The liftgate assembly of claim 1 wherein each of the first and second roller cartridge assemblies comprises a grease fitting.

10. A method comprising the steps of:
(A) providing a liftgate assembly comprising: at least one rail member that may be attached to an associated vehicle, the rail member comprising a channel; at least one runner that is movable within the channel, the runner comprising first and second engagement surfaces; and, a platform operatively attached to the runner, the platform comprising a traffic surface that may be used to receive traffic for loading and unloading cargo;
(B) providing a first roller cartridge assembly comprising a cartridge and at least one roller that pivots within the cartridge;
(C) providing a second roller cartridge assembly comprising a cartridge and at least one roller that pivots within the cartridge;
(D) movably attaching the first roller cartridge assembly to the rail member so that the first roller cartridge assembly roller may contact the first engagement surface of the runner; and,
(E) fixedly attaching the second roller cartridge assembly to the rail member so that the second roller cartridge assembly roller may contact the second engagement surface of the runner.

11. The method of claim 10 wherein step (D) comprises the step of:
pivotally attaching the first roller cartridge assembly to the rail number.

12. The method of claim 11 wherein step (D) further comprises the step of:
attaching a force generating member at one end of the first roller cartridge assembly cartridge to hold the first roller cartridge assembly roller against the first engagement surface of the runner.

13. The method of claim 10 wherein steps (D) and (E) comprise the step of:
positioning the first and second roller cartridge assemblies within the channel on opposite sides of the rail member.

14. The method of claim 10 wherein step (C) comprises the step of:
providing the second roller cartridge assembly with a pair of rollers that are positioned on opposite ends of the second roller cartridge assembly cartridge and that pivot within the second roller cartridge assembly cartridge and contact the second engagement surface of the runner.

15. The method of claim 10 wherein step (C) comprises the step of:
providing the second roller cartridge assembly with a power switch mounted within the second roller cartridge assembly cartridge, the power switch for use in adjusting the position of the platform.

16. The method of claim 10 wherein step (C) comprises the step of:
providing the second roller cartridge assembly with a down stop mechanism mounted within the second roller cartridge assembly cartridge, the down stop mechanism for use in adjusting the position of the platform.

17. The method of claim 10 wherein:
step (B) further comprises the step of providing the first roller cartridge assembly with a grease fitting; and,
step (C) further comprises the step of providing the second roller cartridge assembly with a grease fitting.

18. The method of claim 15 further comprising the step of:
removing the second roller cartridge to access the power switch.

19. The method of claim 16 further comprising the step of:
removing the second roller cartridge to access the down stop mechanism.
